(19) United States
(12) Patent Application Publication
(10) Pub. No.: US 2006/0044635 A1
(43) Pub. Date: Mar. 2, 2006

(54) Image file processing method and related technique thereof

(76) Inventors: Masato Suzuki, Shiga-gun (JP); Shiro Yoshioka, Nishinomiya-shi (JP); Tomoo Nakayama, Nagaokakyo-shi (JP); Takashi Okamoto, Nagaokakyo-shi (JP)

Correspondence Address: MCDERMOTT WILL & EMERY LLP, 600 13TH STREET, N.W., WASHINGTON, DC, 20005-3096, US

(21) Appl. No.: 11/216,191

(22) Filed: Sep. 1, 2005

(30) Foreign Application Priority Data
Sep. 1, 2004 (JP) 2004-254208

(51) Int. Cl. H04N 1/40

(52) U.S. Cl. 358/527; 358/448

(57) ABSTRACT

An image processing method, comprising registering in advance, to a database, fundamental information and additional information related with the fundamental information, obtaining a first image file, extracting a characteristic information from the first image file, searching a fundamental information of the database which is similar to the characteristic information; and getting a first additional information related with the fundamental information.

### BACKGROUND OF THE INVENTION

1. Field of the Invention

The present invention relates to an image file processing method for processing an image and the like picked up by a digital camera, etc., an image file distributing method for distributing a stored image file through a network such as Internet, an image file retrieving method for retrieving an image file through a network such as Internet, and a method for processing a stored image file.

2. Description of the Related Art

There has been a demand in these days for enabling to store a vast amount of picked up images which are picked up by a camera and to effectively retrieve a desired image from a vast amount of the stored images. For achieving this, various image file processing methods and image retrieving devices have been proposed.

As disclosed in “Digital Still Camera Image File Format Standard Exif 2.2”, it is conventionally possible to record property information such as the picked-up time and location in a picture data which is picked up by a digital still camera. There is even a type of digital still camera, which has a function of automatically recording the picked-up time and its positional information by using information obtained from a built-in clock, GPS, etc. according to each format.

Japanese Patent No. 2943265 discloses a following camera. In this camera, information on the picked-up date, location, weather, name of a person (persons), indoor/outdoor, portrait/landscape, event, or audio is automatically recorded at the time of picking up an image or it is inputted afterwards by a person who picked up the image. The information is recorded along with the image file. With this camera, by designating the type of data and inputting the designated data, an image having the same content as that of the data can be retrieved.

Japanese Patent Unexamined Publication No. 8-110911 and Japanese Patent Unexamined Publication No. 2001-43240 disclose a following information apparatus. Each of the information apparatuses handles schedule information which contains time data as related data and image information. When information retrieval is carried out by given schedule information, as a result, there is outputted image information having the same content as the time data which is related to the schedule information or the information which has at least a part of the time data as the related information.

Japanese Patent Unexamined Publication No. 2001-282813 discloses a multimedia data retrieving method/multimedia data retrieving device, which manage multimedia data by relating the time information and the positional information. In this method/device, retrieval action is carried out next by using an index information providing method and an index server. That is, by utilizing an event database which is related to two pieces of information on time and location, the range of the time and location as a retrieval target, which is designated by the name of the event or the combination thereof, is obtained. The multimedia data having the time information and the positional information within the range is retrieved.

Japanese Patent Unexamined Publication No. 2004-5534 discloses a technique which saves a sensitive-expression keyword by relating it to the image as accompanying information thereof. In this technique, there is prepared a database wherein types of image scenes and sensitive-expression keywords being related to the types are stored in advance. Before saving the image, the type of the image scene is determined by extracting the scene from the image. A sensitive-expression keyword is obtained by referring to the database using the determined type, and the obtained sensitive-expression keyword is related to the image as the accompanying information thereof.

Japanese Patent Unexamined Publication No. 2001-238168 discloses a camera which can preferably display a desired image by a short-time and simple operation among a plurality of image files recorded in a recording unit. In this camera, priority order is given at the time of picking up a picture or thereafter, and the priority order is added as the accompanying information. Thereby, the above-described function is made possible.

For an image retrieving device, it is desired to improve simplicity of retrieval operation in the cases where a user has forgotten a keyword used for searching, etc. However, even though various image file processing methods and image retrieving devices are proposed in the above-described related art, simplicity of the retrieval operation in such cases has not been improved.

In Japanese Patent Unexamined Publication No. 2001-282813 described above, there requires an access to the database for searching so that it is necessary to make an access to the network every time a retrieval operation is carried out, which extends the processing time. In addition, it is not possible to search the image file when it is not connected to the network since there is no database.

Furthermore, in Japanese Patent Unexamined Publication No. 2001-238168 described above, it requires a human work for setting the priority order of pictures.

### SUMMARY OF THE INVENTION

A main object of the present invention therefore is to provide an image file processing method which enables to effectively retrieve a desired image file from a vast amount of image files without imposing the burden on a user to go through a work for adding a keyword, etc.

In order to overcome the aforementioned problems, the image file processing method of the present invention comprises: registering in advance, to a database, fundamental information and additional information related with the fundamental information; obtaining a first image file; extracting a characteristic information from the first image file; searching a fundamental information of the database which is similar to the characteristic information; and getting a first additional information related with the fundamental information.

The present invention is preferable to further comprise: adding the first additional information to accompanying information of the first image file; and registering the first image file to the database.

Examples of the fundamental information and the characteristic information may be: accompanying information which is added to the first image file or related to the first image file; and information which shows the characteristics of the object on image that appears as an image in the image file (more preferably, a plurality of pieces of characteristic information of the object on image).

An example of the additional information may be a personal keyword of an object person that appears as an image in the image file.

In the present invention, the characteristic information (personal keywords such as name of the object person, title, or the like, picked-up time, picked-up location, etc) is extracted from the image file such as a picked-up image, obtained image, produced image, etc. for searching the database. Thereby, it enables to extract the additional information (personal keyword and the like) which corresponds to the characteristic information.

With this, it is possible to add the extracted additional information to the accompanying information of the image file and to record/save it as the registered image file along with the image file. Thus, it becomes possible to effectively search the registered image file when a user simply inputs the additional information (personal keyword and the like). It is possible to retrieve the registered image promptly without additionally imposing load on the device, e.g. making an access to the database at the time of searching. Moreover, it is possible to perform searching even when it is not connected to a network. Also, it is possible to carry a retrieving device. Further, the characteristic information is added to the image file so that it enables to perform similar retrieval operation even in the case where the image file is distributed to other parties.

In the image file processing method of the present invention, as the fundamental information and the characteristic information, it is possible to use information which shows the characteristics of the object on image that appears as an image in the image file (for example, image information such as the “face of the person”) of the object on image to be appeared as an image in the image file.

Further, the fundamental information and the characteristic information are preferable to be a plurality of pieces of information which shows the characteristics of the object on image. With this, the accuracy of identifying the object can be improved by using a plurality of pieces of the information as the fundamental information and the characteristic information.

Furthermore, it is preferable to further extract, as the characteristic information, a type of the object from the information showing the characteristics of the object on image, and search the fundamental information which is similar to the information showing the characteristics of the object on image and the type so as to obtain the first additional information. With this, the accuracy of identifying the object can be improved by using a plurality of pieces of characteristic information.

Moreover, it is preferable to extract, as the characteristic information, information which shows the characteristic of the object person on image that appears in the image file from the image file, to identify the object person from the extracted information which shows the characteristics of the object person on image of the object person on image, and to perform communication between an information apparatus which is owned by the identified object person so as to obtain the fundamental information regarding the object person.

With this, it is possible to automatically and highly accurately identify the object person through directly communicating with the information apparatus (portable telephone or the like) owned by the object person by means of Bluetooth, radio LAN, infrared communication, etc.

Further, the additional information is preferable to be a distribution-target address of the image file, and the image file processing method is preferable to form a distribution-target list based on the distribution-target addresses extracted as the first additional information and to distribute the image file to the distribution-target address based on the formed distribution-target list through Internet. With this, it enables to reduce the burden on the user in terms of forming the distribution-target list of the image file.

Furthermore, the present invention is preferable to be structured as follows. Up-record of the image file as one of the fundamental information and a network address of an object person that appears in the up-record as one of the additional information are related to each other to be registered to the database. From the image file, up-record of the image file is extracted as the characteristic information. The up-record as the fundamental information which is similar to the extracted up-record as the characteristic information is searched in the database for obtaining a network address of the object person that appears on the up-record as the first additional information. Further, the image file processing method comprises forming a search target list in which the extracted network address and the object person are related.

With this, it is possible to retrieve the image file by referring to the database using the up-record of the image file for an individual. As a result, it enables to automatically and effectively make a selection from a great number of retrieval targets.

Furthermore, the present invention is preferable to be structured as follows. Personal information of an object person that appears as an image in the image file as one of the fundamental information and a network address of the object person as one of the additional information are related to each other to be registered to the database. The personal information of the object person that appears in the image file is extracted from accompanying information which is added to the image file as the characteristic information. The personal information as the fundamental information which is similar to the extracted personal information as the characteristic information is searched in the database for obtaining, as the first additional information, a network address of the object person which is related to the personal information. Further, the image file processing method comprises forming a search target list in which the extracted network address and the object person are related.

With this, it is possible to select the retrieval target of the image file by referring to the database using the personal information of the image file. As a result, it enables to automatically and effectively make a selection from a great number of retrieval targets.

Moreover, the present invention is preferable to be structured as follows. The accompanying information of the image file as one of the fundamental information and an event as one of the additional information are related to each other, which, in a state where importance of the event is added, are registered to the database. The accompanying information added to the image file is extracted as the characteristic information. The accompanying information of the image file is searched in the database as the fundamental information which is similar to the accompanying information as the extracted characteristic information so as to obtain the event which is related to the accompanying information. The event as the additional information is added to the accompanying information along with the importance. With this, it enables to reduce the burden on the user to set the importance of the image file.

Further, the present invention is preferable to be structured as follows. The characteristic information is accompanying information of the first image file constituted of picked-up time and thumbnail image, the fundamental information is picked-up time, and the additional information is calendar information. The picked-up time as the fundamental information which is similar to the picked-up time as the characteristic information is searched in the database, and the calendar information as the additional information is obtained by relating it to the thumbnail image as the characteristic information. Further, the image file processing method comprises displaying the thumbnail image and the calendar information by relating both to each other. With this, it is possible to retrieve the registered image even under an indistinct memory without inputting a keyword at the time of searching, since the thumbnail for the image file is displayed by corresponding to the calendar information such as the scheduler. Further, it is also possible to search the registered image file based on the personal keyword.

The image file processing method and the image managing device of the present invention are effective on a system for saving the image files picked up by a portable telephone with a built-in camera, on a distribution and retrieval system of the images on Web sites, etc.

### BRIEF DESCRIPTION OF THE DRAWINGS

Other objects of the present invention will become clear from the following description of the preferred embodiments and the appended claims. Those skilled in the art will appreciate that there are many other advantages of the present invention possible by embodying the present invention.

FIG. 1 is a block diagram for showing the schematic structure of an image managing device for saving an image file according to a first embodiment of the present invention;

FIG. 2 is a flowchart for showing a flow of an image file processing method according to the first embodiment;

FIG. 3 is a block diagram for showing a more specific example of the schematic structure of the image managing device for saving the image file according to the first embodiment;

FIG. 4 is a specific example of a personal database for carrying out the image file processing method according to the first embodiment;

FIG. 5 is a block diagram for showing the schematic structure of an image managing device for saving an image file according to second and third embodiments;

FIG. 6 is a flowchart for showing a flow of an image file processing method according to the second embodiment;

FIG. 7 is a block diagram for showing a more specific example of the schematic structure of the image managing device for saving an image file according to the second, fourth, and fifth embodiments of the present invention;

FIG. 8 is a specific example of a personal database for carrying out the image file processing method according to the second embodiment;

FIG. 9 is a flowchart for showing a flow of an image file processing method according to the third embodiment;

FIG. 10 is a specific example of a personal database for carrying out the image file processing method according to the third embodiment;

FIG. 11 is a block diagram for showing a more specific example of the schematic structure of an image managing device for saving the image file according to the third embodiment;

FIG. 12 is a block diagram for showing the schematic structure of an image managing device for saving the image file according to the fourth embodiment;

FIG. 13 is a flowchart for showing a flow of an image file processing method according to the fourth embodiment;

FIG. 14 is a specific example of a personal database for carrying out the image file processing method according to the fourth embodiment;

FIG. 15 is a block diagram for showing the schematic structure of an image managing device for saving the image file according to the fifth embodiment;

FIG. 16 is a flowchart for showing a flow of an image file processing method according to the fifth embodiment;

FIG. 17 is a block diagram for showing the schematic structure of a device for carrying out an image file distribution method according to a sixth embodiment of the present invention;

FIG. 18 is a flowchart for showing a flow of the image file distribution method according to the sixth embodiment;

FIG. 19 is a specific example of the image file for carrying out the image file processing method according to the sixth embodiment;

FIG. 20 is a specific example of a personal database for carrying out the image file processing method according to the sixth embodiment;

FIG. 21 is a block diagram for showing the schematic structure of a device for carrying out an image file retrieving method according to a seventh embodiment of the present invention;

FIG. 22 is a flowchart for showing a flow of the image file retrieving method according to the seventh embodiment;

FIG. 23 is a block diagram for showing the schematic structure of a device for carrying out an image file retrieving method according to an eighth embodiment of the present invention;

FIG. 24 is a flowchart for showing a flow of the image file retrieving method according to the eighth embodiment;

FIG. 25 is a block diagram for showing the schematic structure of an image managing device for saving an image file according to a ninth embodiment of the present invention;

FIG. 26 is a flowchart for showing a flow of an image file processing method according to the ninth embodiment of the present invention;

FIG. 27 is a block diagram for showing the schematic structure of a device for carrying out an image file processing method according to a tenth embodiment of the present invention;

FIG. 28 is a flowchart for showing a flow of an image file processing method according to the tenth embodiment; and

FIG. 29 is a specific example of a screen of the image managing device for carrying out the image file processing method according to the tenth embodiment.

### DETAILED DESCRIPTION OF THE INVENTION

In the followings, preferred embodiments of the image file processing method according to the present invention will be described in detail by referring to the accompanying drawings. In the description provided below, to obtain an image file is generally referred to as “obtaining the image file” when taking a picture by a digital still camera, portable telephone with built-in camera, and the like or when uploading the picture data on Web sites through connecting to a network.

(First Embodiment)

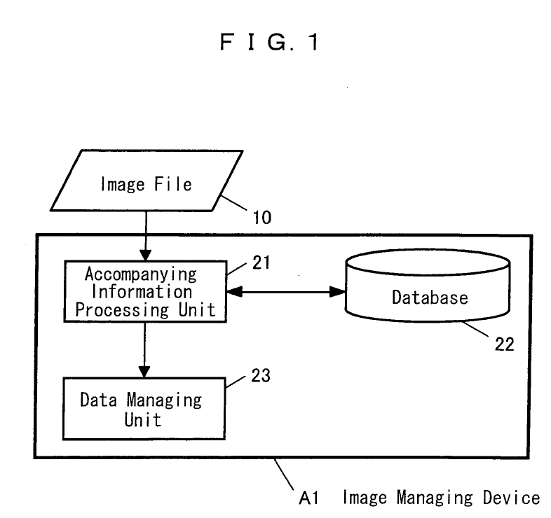

FIG. 1 is a block diagram for showing the schematic structure of an image managing device for saving an image file according to a first embodiment of the present invention. Reference numeral 10 is an image file picked up by a digital still camera or the like, and the image file 10 has accompanying information. An image managing device A1 comprises an accompanying information processing unit 21, a database 22, and a data managing unit 23.

The accompanying information processing unit 21 performs processing for adding a personal keyword to the accompanying information of the image file 10. In the database 22, the accompanying information and the personal keyword are stored by being related to each other. The data managing unit 23 stores the image file 10 to which the personal keyword is added as the accompanying information.

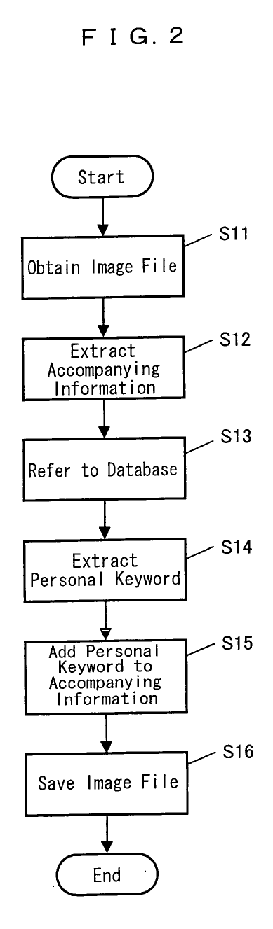

In the followings, action of the image managing device according to the first embodiment will be described by referring to a flowchart of FIG. 2. First, the accompanying information processing unit 21 obtains the image file 10 from outside (S11). The image file 10 is produced by being picked up by a digital still camera, for example. The accompanying information processing unit 21 extracts the accompanying information such as the picked-up time, picked-up location, etc. of the obtained image file 10 as characteristic information (S12). Further, the accompanying information processing unit 21 refers to the database 22 which relates the fundamental information which relates (the same contents in this embodiment) to the accompanying information such as the picked-up time, picked-up location and the personal keyword (S13) so as to extract the personal keyword (S14). The personal keyword is one of the additional information of the object person that appears as an image in the image file. The accompanying information processing unit 21 adds the extracted personal keyword to the accompanying information of the image file 10 (S15). Further, the accompanying information processing unit 21 saves, in the data managing unit 23, the image file 10 with the accompanying information to which the personal keyword is added (S16). The image file 10 is stored in the data managing unit 23 as a registered image file 10a.

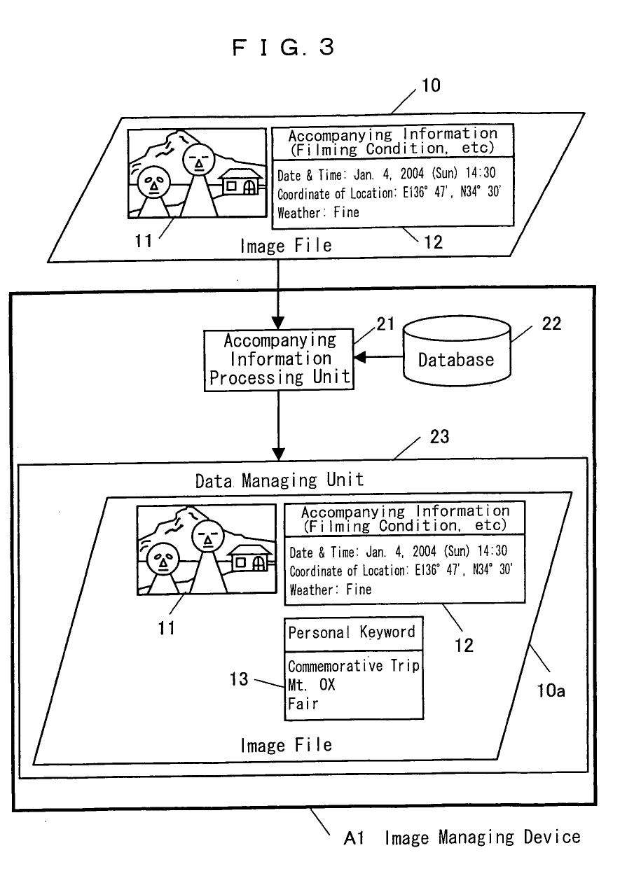

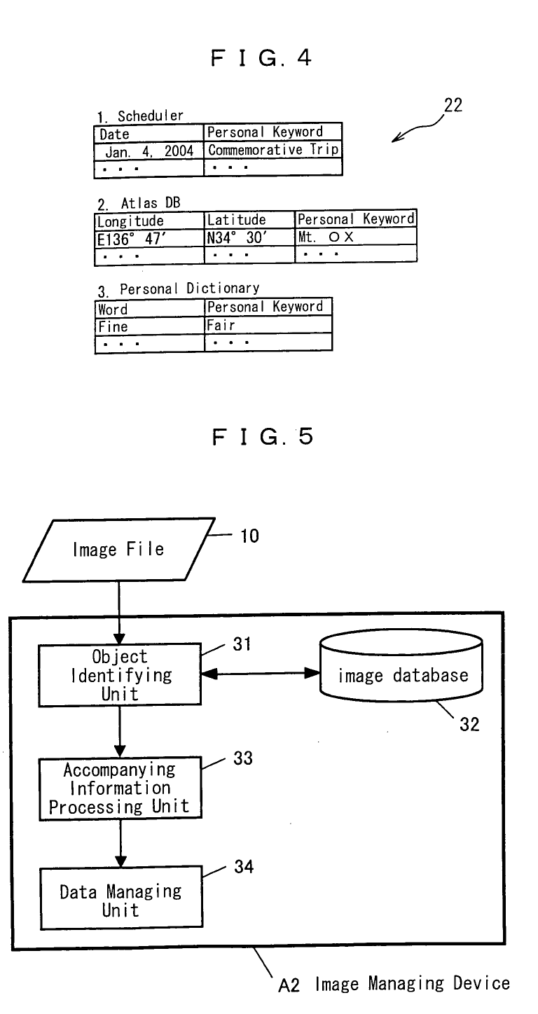

The action of this embodiment will be described in more detail by referring to FIG. 3 and FIG. 4. Description herein will be provided on assumption that the image file 10 is picked up by a GPS portable telephone with a built-in camera. A GPS portable telephone is a portable telephone with a GPS (Global Positioning System), which is capable of obtaining the positional information of the location at the time of picking up a picture and recording the image data along with the positional information.

The image file 10 picked up by the GPS portable telephone with a built-in camera is constituted of an image data 11 and accompanying information 12 such as time information, positional information, weather, and the like. The image managing device A1 is mounted to the GPS portable camera with a built-in camera. The image managing device A1 obtains the image file 10 which is picked up by the portable telephone (S11).

The database 22 comprises tables (see FIG. 4) of a scheduler, atlas database, personal dictionary, etc. In the database 22, the accompanying information 12 and the personal keyword (additional information) are recorded by being related to each other. Here, the personal keyword “commemorative trip” is related to the accompanying information 12 (schedule: “Jan. 4, 2004”), the keyword “Mt. OX” is related to the accompanying information 12: (atlas DB “longitude E136° 47′: latitude N34° 30′”, and the personal keyword “fair” is related to the accompanying information 12: (personal dictionary “fine weather”). The processing for storing the above-described relevance data to the database 22 is performed by a user, for example, as pre-processing for obtaining the image file 10. The accompanying information 12 recorded in the database 22 and the accompanying information 12 stored in the image file 11 are similar and related to each other. However, each set of information is formed separately and stored to the database 22 and the image file 11 individually. The accompanying information 12 recorded in the database 22 is the information which corresponds to the fundamental information while the accompanying information 12 stored in the image file 11 is the information which corresponds to the characteristic information.

The accompanying information processing unit 21 refers the accompanying information “Jan. 4, 2004”, which is added to the obtained image file 10, to the database 22 (S13) for searching the accompanying information (fundamental information) which is similar to the accompanying information (characteristic information) “Jan. 4, 2004”. Thereby, the personal keyword “commemorative trip” which is related to the accompanying information is obtained. In the same manner, the accompanying information processing unit 21 obtains the personal keyword “Mt. OX” which is related to the accompanying information “E136° 47′, N34° 30′”. Similarly, the accompanying information processing unit 21 obtains the personal keyword “fair” which is related to the accompanying information (characteristic information) “fine weather” (S14).

The accompanying information processing unit 21 additionally adds the obtained personal keyword to the accompanying information of the image file 10 (S15), and saves the image file 10 in the data managing unit 23 as the registered image file 10a (S16).

In the manner as described above, the personal keyword is added to the image file 10 as the accompanying information, and the image file 10 in this state is saved in the data managing unit 23 as the registered image file 10a. Therefore, when a user searches for the image file 10, the image file 10 can be retrieved effectively by simply inputting the personal keyword “commemorative trip” or “Mt. OX” into the data managing unit 23. In addition, since the personal keywords are added prior to the retrieval operation, it is possible to retrieve the registered image promptly without imposing load on the device, e.g., making an access to the database 22 at the time of searching. Moreover, it is possible to perform searching even when it is not connected to a network. Also, it is possible to carry the data managing unit 23 which can retrieve the image file 10 with the personal keywords. Further, the personal keywords are added to the image file 10 so that it enables to perform similar retrieval operation even in the case where the image file 10 is distributed to other parties.

(Second Embodiment)

FIG. 5 is a block diagram for showing the schematic structure of an image managing device A2 for saving an image file according to a second embodiment of the present invention. The image managing device A2 comprises an object identifying unit 31 which identifies an object from an image file 10, an image database 32 which relates the image and a personal keyword, an accompanying information processing unit 33 for adding the personal keyword to the accompanying information of the image file 10, and a data managing unit 34 for storing the image file 10.

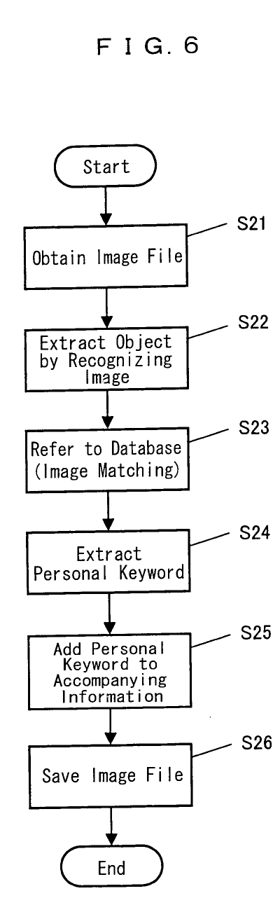

In the followings, action of the image managing device according to the second embodiment will be described by referring to a flowchart of FIG. 6. First, the image managing device A2 obtains the image file 10 (S21). The image file 10 is produced by being picked up by a digital still camera, for example. The object identifying unit 32 of the image managing device A2 performs image recognition processing on the obtained image file 10 so as to extract, as the characteristic information, partial image data such as “face” or the like, which is characteristic information of the object on image (S22). The database 32, for example, is a personal address book with a picture of the object face, in which the information showing the characteristics of the object on image (face-area image data) and the personal keyword are stored by being related to each other. In the image database 32, the information showing the characteristics of the object on image is stored as the fundamental information and the personal keyword is stores as the additional information, respectively. The processing for storing the relevance data to the image file database 32 is performed by a user as pre-processing for obtaining the image file 10.

The object identifying unit 31 collates the extracted partial image data (fundamental information) such as the “object face” with each piece of the information (fundamental information) showing the characteristics of the object on image which is stored in the image database 32 (S23). Collation is carried out by performing image matching processing or the like. The object identifying unit 31 identifies the object by verifying that the both information showing the characteristics of the object on image being collated are identical to each other. When the identification is completed, the object identifying unit 31 extracts the identified personal keyword from the image database 32 and supplies it to the accompanying information processing unit 33 (S24).

The accompanying information processing unit 33 additionally adds the personal keyword, which is supplied from the object identifying unit 31, to the accompanying information of the image file 10 (S25), and saves the image file 10 in the data managing unit 34 as a registered image file 10a (S26).

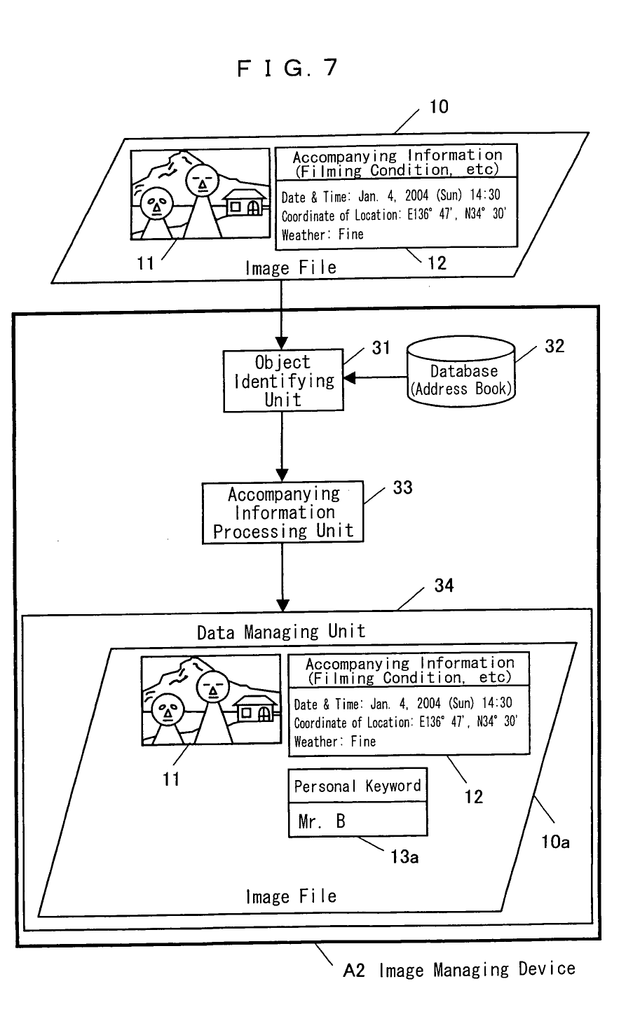

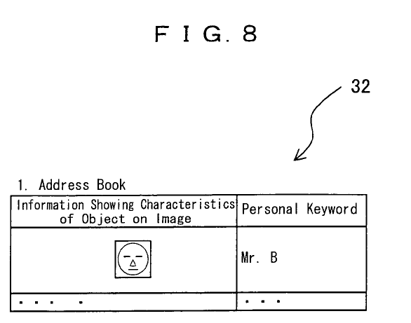

The action of the second embodiment will be described in more detail by referring to FIG. 7 and FIG. 8. The image file 10 is constituted of image data 11 and accompanying information 12 such as time information, positional information, weather, etc. The image managing device A2 obtains the image file 10 having such structure (S21).

The database 32 comprises a table as shown in FIG. 8. The object identifying unit 31 performs image recognition processing on the image data 11 so as to extract partial image data (characteristic information)of the “face” area of the object within the image data 11 (S22). Further, the object identifying unit 31 refers the extracted partial image data (face) of the object to the information (fundamental information) which shows the characteristic of the object on image, which is stored in the image database 32 (S23). Collation is carried out by performing image matching processing, for example. The identification herein means to determine the extracted object as a specific individual. Further, the object identifying unit 31 extracts the “personal keyword” of the identified object from the image database 32 (S24). Here, it is assumed that “Mr. or Ms. B” (simply referred to as “Mr. B” hereinafter) is extracted as the personal keyword of the identified object.

The accompanying information processing unit 33 additionally adds the personal keyword “Mr. B” to the accompanying information of the image file 10 (S25), and saves the image file in the data managing unit 34 as the registered image file 10a (S26).

In the manner as described above, the personal keyword of the object can be automatically obtained and the obtained personal keyword cab be added to the accompanying information of the image file. As a result, by the retrieving processing using the personal keyword “Mr. B”, the image file 10 can be retrieved from the data managing unit 34.

(Third Embodiment)

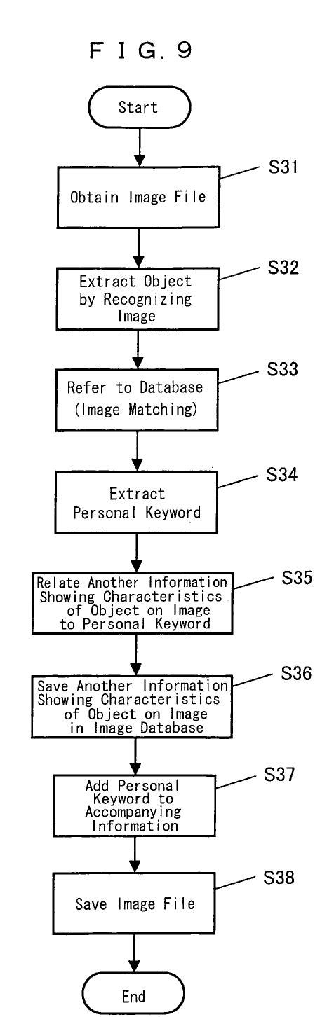

In the followings, action of a third embodiment will be described by referring to a flowchart of FIG. 9. In the third embodiment, the device of FIG. 5 is used like the case of the second embodiment. The third embodiment is distinctive in respect that a step S35 and a step S36 are additionally provided to the flowchart of the second embodiment.

In a step S32, another partial image data such as “cloth” or the like is extracted, as the characteristic information which characterizes the image file 10, along with the partial image data of “object face” for characterizing the image file 10.

In the step S35, the personal keyword is related to the other partial image data (the information showing the characteristic of the object on image (for example, cloth)), which is different from the partial image data (the information showing the characteristic of the object on image (face) used in the step S33 (S35), among the characteristic information of the object on image for characterizing the image file 10, which is extracted by the object identifying unit 31 in the step S32. In the next step S36, another piece of information (cloth) showing the characteristic of the object on image along with the personal keyword is saved in the image database 32 (S36). Thus, in the image database 32, not only the relevance between the information (face) showing the characteristic of the object on image and the personal keyword but also the relevance between the information (cloth) showing the characteristic of the object on image and the personal keyword is registered. Thereby, the number of searching keys in the image data base 32 is increased.

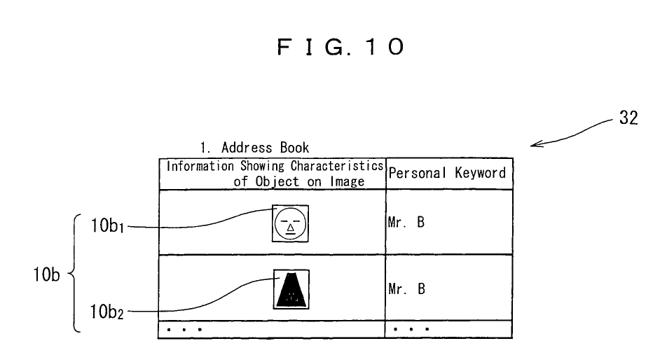

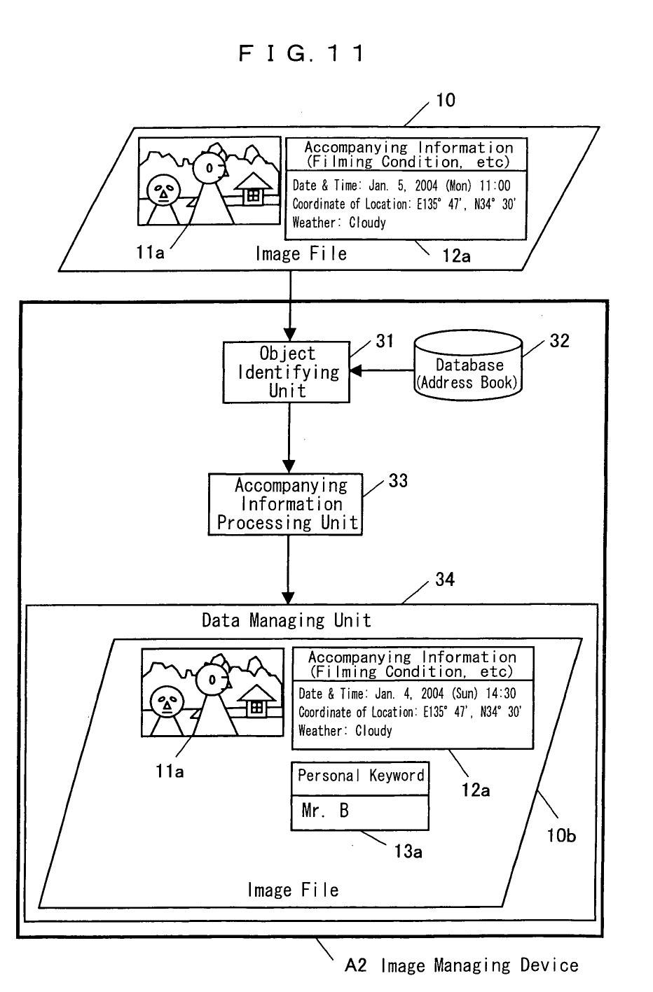

The action of this embodiment will be described in more detail by referring to FIG. 10 and FIG. 11. In the step S35, in addition, still another piece of information (cloth) showing the characteristic of the object on image and the personal keyword “Mr. B” are related to each other and registered to the image database 32. As shown in FIG. 10, an image file 10b, which is constituted of information (face) 10b, showing the characteristic of the object on image and information (cloth) 10b₂ showing the characteristic of the object on image, is related to the personal keyword “Mr. B” to be registered to the image database 32 (S36).

Described now is a case where, after such relating processing is performed, the image managing device A2 of this embodiment obtains the image file 10 as shown in FIG. 11. The object identifying unit 31 recognizes the image of the image data 11. The object (in the center) in the recognized image data 11 faces sideways so that the object identifying unit 31 cannot identify the object with a first object image character (face). However, the personal keyword of the object and a second object image character (cloth) are registered in the image database 32 by being related to each other. Thus, by collating the second partial image data (cloth) in the obtained image file 10 with the second object image character (cloth) registered to the image database 32, the personal keyword of the object is designated as “Mr. B”. Thereby, the object is identified as “Mr. B”.

In this embodiment, by adding the step S35 and the step S36 as described above, it becomes possible to register another piece of information showing the characteristic of the object on image such as “cloth” by relating it to the personal keyword. With this, even if it is difficult to identify the object by the information (face) showing the characteristic of the object on image, the object can be identified by using the information (cloth) showing the characteristic of the object on image. In this embodiment, two pieces of the information showing the characteristics of the object on image are used. However, the present invention may use two pieces or more of the information showing the characteristics of the object on image, and extract a plurality of pieces of information showing a plurality of characteristics of the object on image from the image file 10 to be collated with the database.

(Fourth Embodiment)

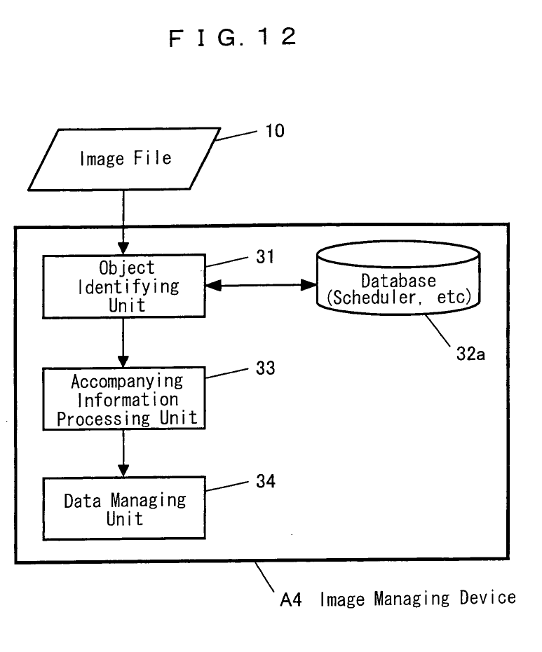

FIG. 12 is a block diagram for showing the schematic structure of an image managing device for storing an image file according to a fourth embodiment of the present invention.

An image managing device A4 comprises an object identifying unit 31 which identifies the object from the image file 10, a database 32a which stores the accompanying information (fundamental information) and a personal keyword by relating them to each other, an accompanying information processing unit 33 for adding the personal keyword to the accompanying information (characteristic information) of the image file 10, and a data managing unit 34 for storing the image file 10.

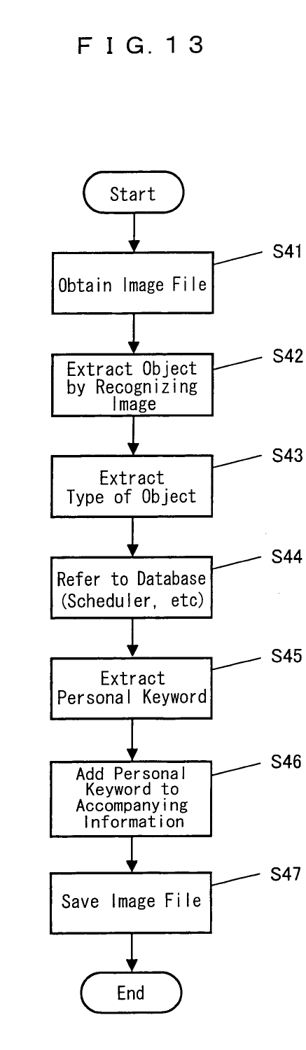

In the followings, action of the image managing device according to the fourth embodiment will be described by referring to a flowchart of FIG. 13. First, the image managing device A4 obtains the image file 10 from outside (S41). The image file 10 is produced by being picked up by a digital still camera, for example. The object identifying unit 31 of the image managing device A4 performs image recognition processing on the obtained image file 10 so as to extract partial image data such as the “object face”, “cloth”, and the like, which is the information showing the characteristics of the object on image (S42).

Further, the object identifying unit 31 extracts a type of the object, for example, “person” (S43). The types herein refer to general names for object groups which are recognized as the same kinds. Examples thereof may be concepts of human-beings, dogs, cars, trains, etc. Normally, one or a plurality of the objects present in a single image file are classified into one of those types by the object identifying unit 31.

In the database 32a, for example, information regarding events such as a scheduler, a personal electric diary, etc. is recorded. The information is inputted by a user to the database 32a in advance. An event is registered by being related to the date of the event, for example, which is one of the accompanying information (fundamental information). Further, in the event information registered o the database 32a, information regarding the types which appears in the event is registered. The information herein regarding the type is the information which specifies the type (person) that appears in the event.

The object identifying unit 31 refers to the database 32a (S44) so as to specify the event based on the picked-up time in the accompanying information. Further, the object identifying unit 31 extracts the personal keyword (additional information) from the information regarding the type of the event. For example, the name of companion as one of the personal keywords is extracted form the type information “human being” (S45), and the extracted personal keyword is outputted to the accompanying information processing unit 33. The accompanying information processing unit 33 additionally adds the personal keyword supplied from the object identifying unit 31 to the accompanying information of the image file 10 (S46). Further, as the registered image file 10a, the accompanying information processing unit 33 saves, in the data managing unit 34, the image file 10 with the accompanying information to which the personal keyword is added (S47).

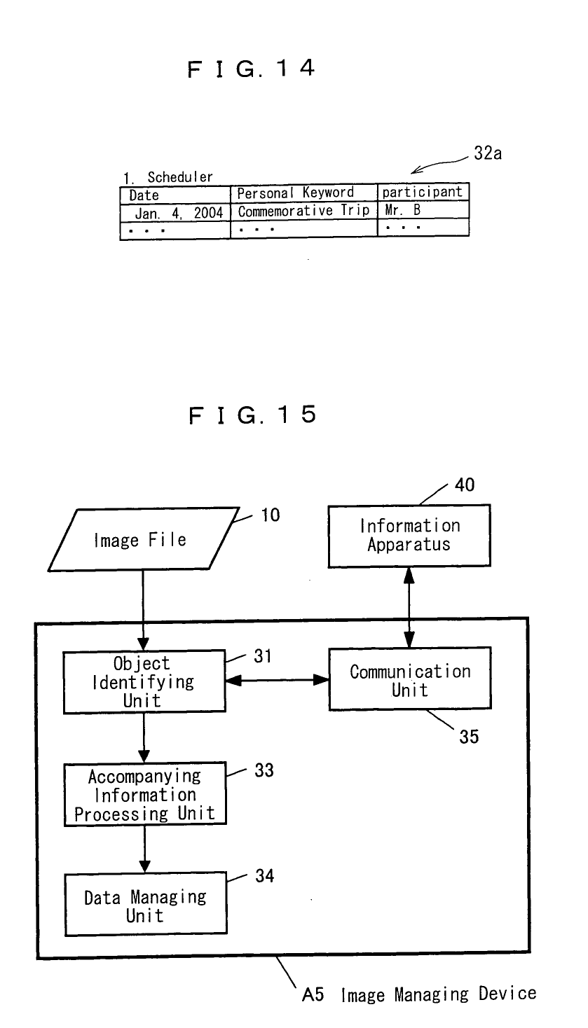

The action of the fourth embodiment will be described in more detail by referring to FIG. 7 and FIG. 14. Unlike the second embodiment, as shown in FIG. 14, the fourth embodiment has a table for specifying the object from the classified types. Further, the object identifying unit 31 extracts the first, second object image characters (face, cloth) by performing image recognition processing on the image data 11 (S42) and, then, extracts the type of the object (“human being” in this case) (S43). The object identifying unit 31 refers the data of the type (human being: participants in FIG. 14) which is related to the date data “January 4” in the accompanying information of the image file 10 to the table (FIG. 14) of the database 32a so as to extract “Mr. B” as the personal keyword which relates to the event and the type (S45).

By performing the above-described action, it is possible to automatically obtain the personal keyword of the object. The accompanying information processing unit 33 adds the obtained personal keyword to the accompanying information of the image file 10 (S46), and saves the image file 10 in the data managing unit 34 as the registered image file 10a (S47).

(Fifth Embodiment)

FIG. 15 is a block diagram for showing the schematic structure of an image managing device for saving an image file according to a fifth embodiment of the present invention.

An image managing device A5 comprises an object identifying unit 31 which identifies the object from an image file 10, a communication unit 35 for communicating between an information apparatus owned by an object person, an accompanying information processing unit 33 which adds the personal keyword to the accompanying information of the image file 10, and a data managing unit 34 for storing the image file 10.

An information apparatus 40 carries owner's information such as information on a portable telephone, digital still camera, and the like, which are owned by the object person, and it is an information apparatus which has communicating function such as IrDA or Bluetooth for enabling to communicate with other apparatuses.

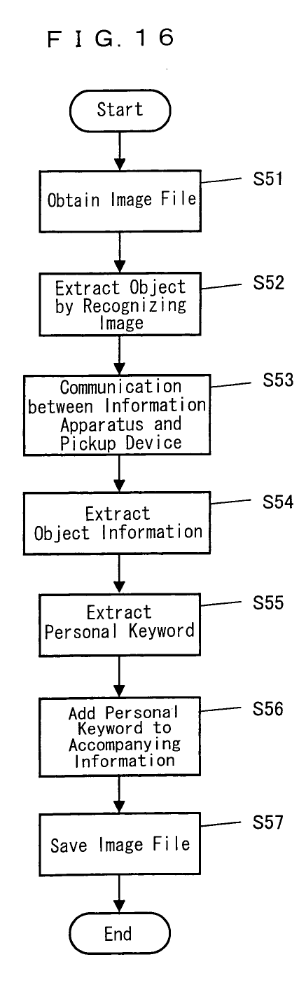

In the followings, action of the fifth embodiment will be described by referring to a flowchart of FIG. 16. First, the image managing device A5 obtains the image file 10 (S51). The image file 10 is produced by being picked up by a digital still camera, for example. The object identifying unit 31 of the image managing device A5 performs image recognition processing on the obtained image file 10 so as to extract partial image data such as the “object face”, “cloth” and the like, which is the information showing the characteristics of the object on image. Further, the object identifying unit 31 extracts a type of the object, for example, “human being” from the extracted information showing the characteristics of the object on image (S52). The types herein are the same as those described in the fourth embodiment.

Next, the image managing device A5 performs communication between the information apparatus 40 through the communication unit 35 (S53), and obtains the owner's information (information on the object) and the like from the information apparatus 40 (S54). Further, the personal keyword is extracted from the owner's information and the like which is extracted in the step S54 (S55). The accompanying information processing unit 33 adds the personal keyword to the accompanying information of the image file 10 (S56) and, then, saves the image file 10 in the data managing unit 34 as the registered image file 10a (S57).

The action of this embodiment will be described in more detail by referring to FIG. 7. Unlike the second embodiment, in the fifth embodiment, the object identifying unit 31 performs image recognition processing on the image data 11 so as to extract the information (face, cloth) showing the characteristics of the object on image (S52). The communication unit 35 performs communication between the information apparatus 40 owned by the object person through a communication form such as IrDA or Bluetooth (S53) so as to obtain the information on the object such as the owner's information from the information apparatus 40 (S54). Thereby, the object identifying unit 31 obtains the personal keyword indicating that the owner is “Mr. B”.

In the manner as described above, the personal keyword for the picked-up object can be obtained automatically, and the obtained personal keyword can be added to the accompanying information of the image file.

(Sixth Embodiment)

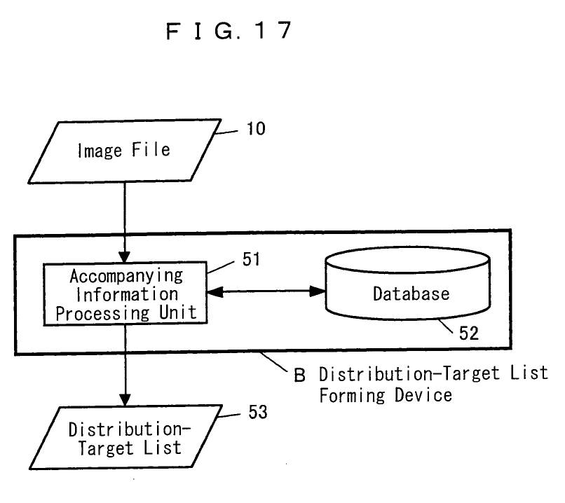

FIG. 17 is a block diagram for showing the schematic structure of a device which forms a list for distributing an image file according to a sixth embodiment of the present invention.

An image file distribution-target list forming device B, which is an image processor of the present invention, comprises an accompanying information processing unit 51 and a database 52. The accompanying information processing unit 51 forms a distribution-target list from the accompanying information of the image file 10. The database 52 relates and records the accompanying information of the image file 10 and the distribution target of the image file (for example, e-mail address, Web-site address, and the like).

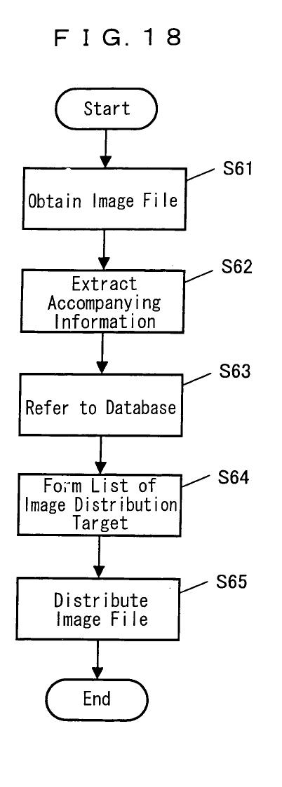

In the followings, action of the sixth embodiment will be described by referring to a flowchart of FIG. 18. First, the distribution-target list forming device B obtains the image file 10 from outside (S61). As a way of example, a file may be obtained by being uploaded from a Web site on the Internet. The accompanying information processing unit 51 extracts the accompanying information (name of the individual as the object, etc) of the obtained image file 10 (S62). Further, the accompanying information processing unit 51 refers the extracted accompanying information to the database 52 (S63) for forming a distribution-target list 53 of the image file (S64). The accompanying information processing unit 51 distributes the image file according to the formed distribution-target list 53 (S65).

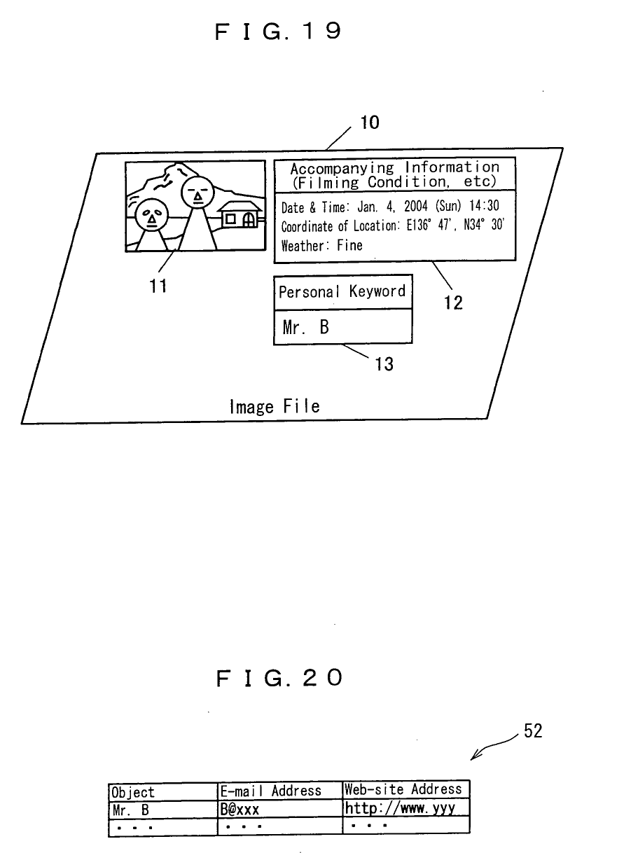

The action of the distribution-target list forming device B will be described in more detail by referring to FIG. 19 and FIG. 20. In the accompanying information of the image file 10 obtained by the distribution-target list forming device B, a personal keyword is recorded along with the data of the picked-up date and the like. Let's assume here that there is “Mr. B” recorded as the data for the name of the object. The distribution-target list forming device B obtains the image file 10 having such data structure from outside (S61). The accompanying information processing unit 51 extracts the accompanying information (personal keyword (name of the person)), “Mr. B”, from the obtained image file 10 (S62) and, then, refers it to the database 52 for extracting the data which is related to the extracted accompanying information from the database 52 (S63).

In a table of the database 52 shown in FIG. 20, an e-mail address “B@xxx” and a Web-site address http://www.yyy are related to the data of the personal name “Mr. B” to be registered. Thus, the e-mail address and Web-site address are extracted as the data which is related to the data of the personal name “Mr. B”.

Further, the accompanying information processing unit 51 adds the e-mail address of “Mr. B”, “B@xxx”, to the mailing list of the distributed mail to which the image file 10 is attached and to the mailing list of an information mail of the Web site from which the image file 10 is uploaded. If not, the Web-site address of “Mr. B”, http://www.yyy, is added to the list of the target for uploading the image file 10. Thereby, the distribution-target list 53 of the image file 10 is automatically formed (S64).

In the manner as described above, it enables to reduce the burden on the user in terms of forming the distribution-target list of the image file.

(Seventh Embodiment)

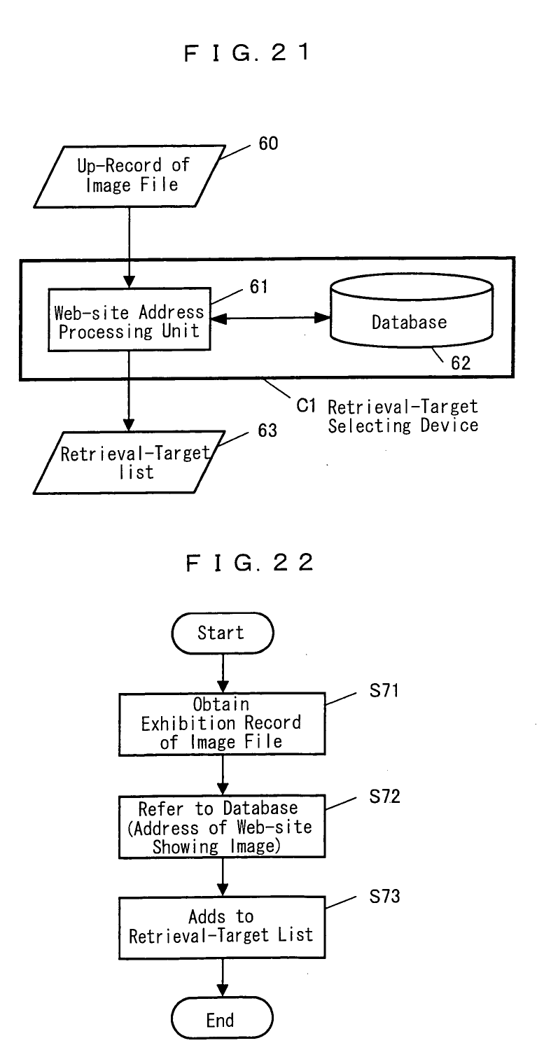

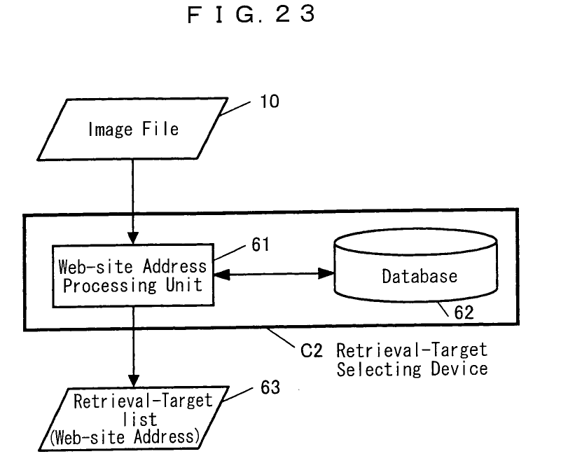

FIG. 21 is a block diagram for showing the schematic structure of a retrieval-target selecting device Cl which is an image managing device according to a seventh embodiment of the present invention. The retrieval-target selecting device C1 is used when the image file 10 is searched on Web sites or the like.

An up-record 60 of the image file is the history data of showing the image file 10 to friends and the like. The retrieval-target selecting device C1 comprises a Web-site address processing unit 61 and a database 62. The Web-site address processing unit 61 makes a list of the Web-site addresses as the search target of the image file from the up-record 60 of the image file. In the database 62, the friends and the like are registered by being related to the Web-site addresses of the friends and the like in which the image files thereof are shown. Reference numeral 63 is a retrieval-target list. The retrieval-target list 63 can be obtained by adding the Web-site addresses. The Web-site addresses herein can be obtained when the retrieval-target selection device C1 refers the up-record 60 to the database 62.

In the followings, action of the seventh embodiment will be described by referring to a flowchart of FIG. 22. First, a Web-site address processing unit 61 obtains the up-record 60 of the image file form outside (S71). The Web-site address of the person on the up-record 60 is obtained by referring to the (image) database 62 (S72), and the Web-site address is added to the retrieval-target list 63.

In the manner as described above, it enables to effectively and automatically to make a selection from a great number of the retrieval targets.

(Eighth Embodiment)

FIG. 23 is a block diagram for showing the schematic structure of a device according to an eighth embodiment of the present invention, which selects the retrieval target when searching the image file on Web sites and the like.

A retrieval-target selecting device C2 comprises a Web-site address processing unit 61 and a database 62. The Web-site address processing unit 61 forms a list of the Web-site addresses as the retrieval target of the image file from the accompanying information of the image file 10. In the database 62, the person such as a friend is related to the address of the Web site showing the image file of that person. A retrieval-target list 63 is the list data which relates the Web-site address and the like to the image file 10.

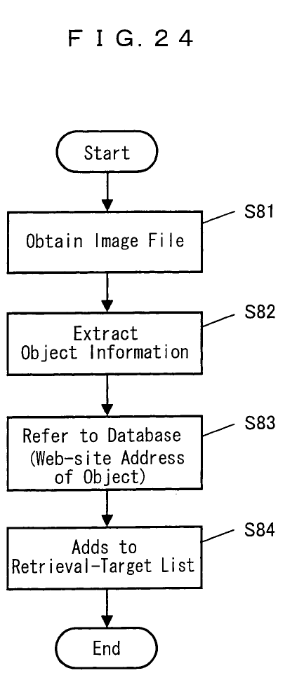

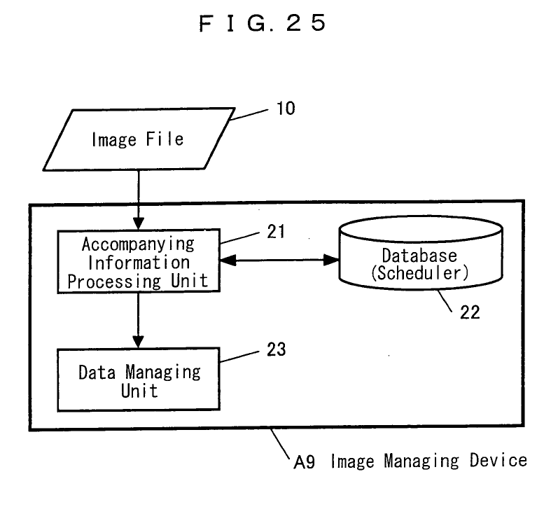

In the followings, action of the retrieval-target selecting device C2 of the eighth embodiment will be described by referring to a flowchart of FIG. 24. First, the retrieval-target selecting device C2 obtains the image file by performing uploading processing or the like of the image file 10 on the Web site (S81). The Web-site address processing unit 61 extracts the object information from the accompanying information of the obtained image file 10 (S82). Further, the Web-site address processing unit 61 refers the extracted object information (person specifying information, Web-site address information of the object) to the database 62 (S83) for adding the Web-site address of the object to the retrieval-target list (S84). In the manner as described above, it enables to automatically and effectively make a selection from a great number of the retrieval targets.

(Ninth Embodiment)

FIG. 25 is a block diagram for showing the schematic structure of an image managing device which gives the importance to the image file according to a ninth embodiment of the present invention.

An image managing device A9 comprises an accompanying information processing unit 21, a database 22, and a data managing unit 23. The accompanying information processing unit 21 adds the importance of the image file to the accompanying information of the image file 10. The database 22 is constituted of a scheduler and the like in which the work day's schedule of the object, etc. is recorded. The data managing unit 23 manages the image files.

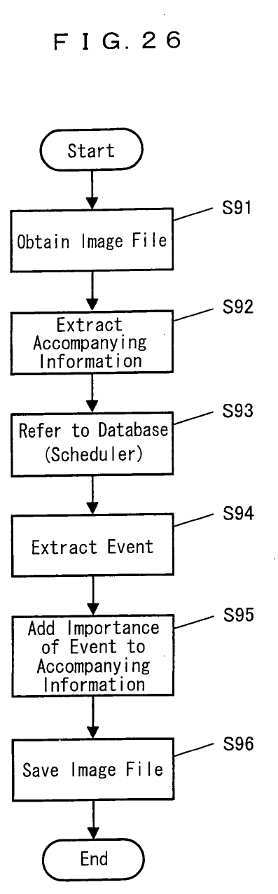

In the followings, action of the ninth embodiment will be described by referring to a flowchart of FIG. 26. First, the image managing device A9 obtains the image file 10 from outside (S91). The image file 10 is produced by being picked up by a digital still camera, for example. The accompanying information processing unit 21 extracts the picked-up time as the accompanying information from the obtained image file 10 (S92). Further, the accompanying information processing unit 21 refers to the database (scheduler) 22 using the extracted picked-up time as a searching key (S93) for extracting from the database 22 an event which is related to the picked-up time (S94). Furthermore, the accompanying information processing unit 21 extracts the importance given to the extracted event and adds the extracted importance to the accompanying information of the image file 10 (S95). The accompanying information processing unit 21 saves in the data managing unit 23 the image file 10 with the accompanying information to which the importance is added in the manner as described above (S96).

The importance herein is determined by a user of the image managing device A9 by setting the degree (high-low) of the importance of each event in advance. The set importance is registered as the data in the database 22.

In the manner as described above, it enables to reduce the burden on the user in terms of setting the importance of the image data 10.

(Tenth Embodiment)

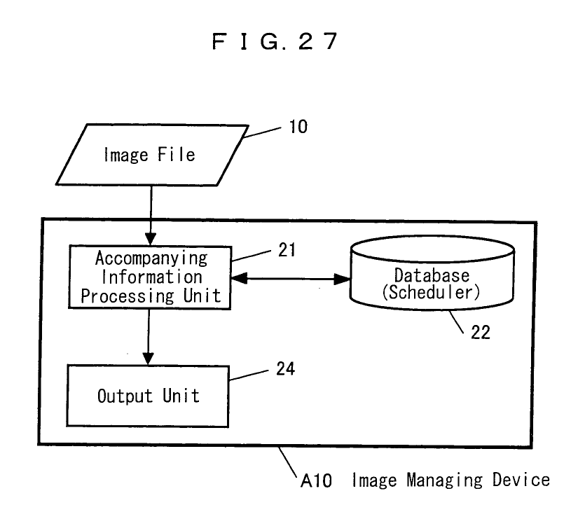

FIG. 27 is a block diagram for showing the schematic structure of an image managing device A10 according to a tenth embodiment of the present invention, which displays thumbnail of the image file on the scheduler (calendar information).

The image managing device 10A comprises an accompanying information processing unit 21, a database 22, and an output unit 24. The accompanying information processing unit 21 extracts the picked-up time from the accompanying information of the image file 10. The database 22 is constituted of the scheduler (calendar information) and the like in which the work day's schedule of the object, etc. is recorded. The output unit 24 outputs and displays the thumbnail of the image file 10.

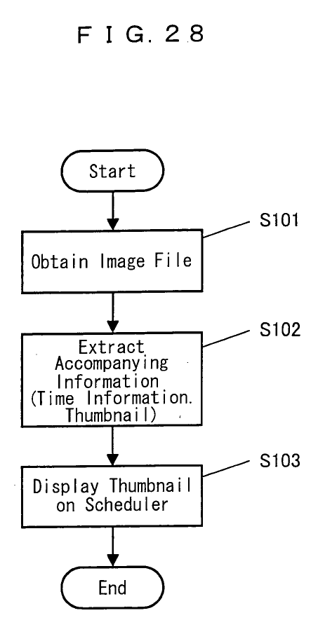

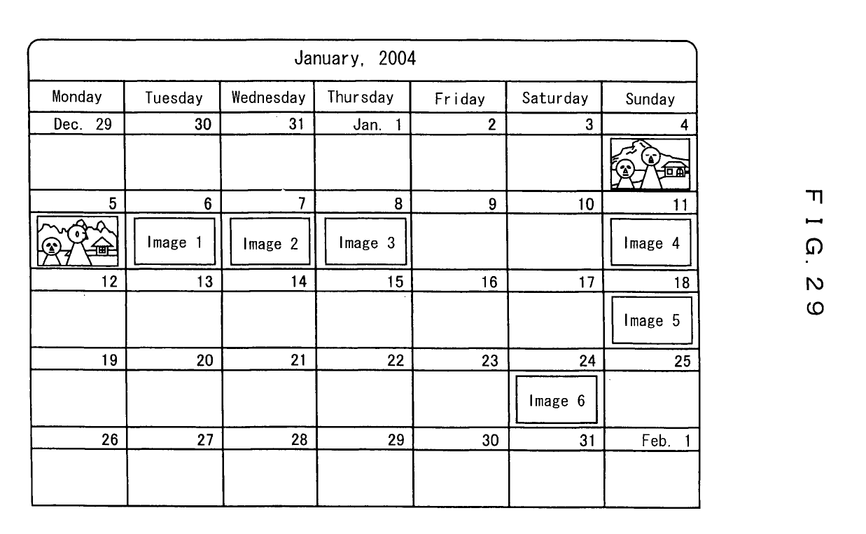

In the followings, action of the image managing device A10 of the tenth embodiment will be described by referring to a flowchart of FIG. 28. First, the image managing device A10 obtains the image file 10 from outside (S101). The image file 10 is produced by being picked up by a digital still camera, for example. Then, the accompanying information processing unit 21 extracts the picked-up time and the thumbnail as the accompanying information (characteristic information) from the obtained image file 10 (S102). Further, the accompanying information processing unit 21 refers the extracted picked-up time to the calendar information (picked-up time) in the database 22 for relating the scheduler (calendar information) and the thumbnail of the image file so as to be registered to the database 22. Furthermore, the accompanying information processing unit 21 displays by the output unit 24 the schedule and the thumbnail which are related to each other.

The action of the tenth embodiment will be described in more detail by referring to FIG. 7, FIG. 11, and FIG. 29. First, the image managing device A10 obtains the image file 10 (S101). The accompanying information processing unit 21 extracts the time information and the thumbnail from the accompanying information of the obtained image file 10 (S102). In the image file 10 shown in FIG. 7, the time information indicates “January 4”, and the time information in the image file shown in FIG. 11 indicates “January 5”. In this case, as shown in FIG. 29, in the scheduler displayed in the output unit 24, a thumbnail is indicated on the data of “January 4” and “January 5”, respectively (S103). In this case, the image file may have a dependent relationship between the event on the scheduler or may be independent.

In the manner as described above, the image file is displayed on the scheduler by a thumbnail in accordance with the picked-up time. Therefore, it is possible to retrieve the registered image even under an indistinct memory without inputting a keyword at the time of searching.

The present invention has been described in detail by referring to the most preferred embodiments. However, various combinations and modifications of the components are possible without departing from the spirit and the broad scope of the appended claims.

What is claimed is:

1. An image file processing method, comprising:
registering in advance, to a database, fundamental information and additional information related to the fundamental information:
obtaining a first image file;
extracting a characteristic information from the first image file;
searching a fundamental information of the database which is similar to the characteristic information; and
getting a first additional information related to the fundamental information.

2. The image file processing method according to claim 1, further comprising:
adding the first additional information to accompanying information of the first image file; and
registering the first image file to the database.

3. The image file processing method according to claim 1, wherein the fundamental information is accompanying information related to the first image file.

4. The image file processing method according to claim 2, wherein the additional information is a personal keyword of an object person that appears as an image in the image file.

5. The image file processing method according to claim 1, wherein the fundamental information and the characteristic information is information showing characteristics of an object that appears as an image in the image file.

6. The image file processing method according to claim 5, wherein the fundamental information and the characteristic information is a plurality of pieces of information showing characteristics of the object person as appeared as an image.

7. The image file processing method according to claim 5, comprising:
as the characteristic information further extracting a type of the object from the information showing the characteristics of the object on image; and
obtaining the first additional information by searching the fundamental information in the database, which is similar to the information showing the characteristics of the object on image and the type.

8. The image file processing method according to claim 1, comprising:
as the characteristic information, extracting, from the image file, information showing characteristics of an object person on image that appears in the image file; and
identifying the object person from the extracted information showing the characteristics of the object person on image and performing communication between an information apparatus which is owned by the identified object person so as to obtain the fundamental information regarding the object person from the information apparatus.

9. The image file processing method according to claim 1, wherein:
the additional information is an distribution-target address of the image file; and
the image file processing method further comprises
forming a distribution-target list from the distribution-target address as the first additional information, and
distributing the image file to the distribution-target address through Internet according to the formed distribution-target list.

10. The image file processing method according to claim 1, comprising:
registering, to the database, up-record of the image file as one of the fundamental information and a network address of an object person that appears in the up-record as one of the additional information by relating both to each other;
extracting the up-record of the image file from the image file as the characteristic information; and
searching, in the database, the up-record as the fundamental information which is similar to the extracted up-record as the characteristic information for obtaining, as the first additional information, the network address of the object person that appears on the up-record, wherein
the image file processing method further comprises
forming a search target list in which the extracted network address and the object person are related.

11. The image file processing method according to claim 1, comprising:
registering, to the database, personal information of an object person that appears as an image in the image file, which is one of the fundamental information, and a network address of the object person as one of the additional information by relating both to each other;
extracting, from the accompanying information which is added to the image file as the characteristic information, personal information of the object person that appears in the image file; and
searching, in the database, the personal information as the fundamental information which is similar to the extracted personal information as the characteristic information for obtaining, as the first additional information, a network address of the object person that is related to the personal information, wherein
the image file processing method further comprises
forming a search target list in which the obtained network address and the object person are related.

12. The image file processing method according to claim 2, comprising:
relating accompanying information of the image file as one of the fundamental information and an event as one of the additional information to each other, which, in a sate where importance of the event is added, are registered to the database;
extracting the accompanying information added to the image file as the characteristic information;
searching, in the database, the accompanying information of the image file as the fundamental information which is similar to the extracted accompanying information as the characteristic information for obtaining the event which is related to the accompanying information; and
adding the event as the additional information along with the importance to the accompanying information of the image file.

13. The image file processing method according to claim 1, wherein:
the characteristic information is accompanying information of the image file constituted of picked-up time and thumbnail image, the fundamental information is picked-up time, and the additional information is calendar information;
the picked-up time as the fundamental information, which is similar to the picked-up time as the characteristic information, is searched in the database; and
the calendar information as the additional information is obtained by relating it to the thumbnail image as the characteristic information, wherein
the image file processing method further comprises
displaying the thumbnail image and the calendar information by relating both to each other.

14. An image managing device, comprising:
a database for registering fundamental information and additional information regarding the fundamental information; and
an accompanying information processing unit which extracts characteristic information from an image file obtained from outside and searches the fundamental information in the database, which is similar to the extracted characteristic information, so as to obtain an first additional information which is related to the fundamental information.

15. The image managing device according to claim 14, wherein
the accompanying information processing unit adds the first additional information to accompanying information of the image file; and
the image managing device further comprises a data managing unit which saves, as a registered image file, the image file with the accompanying information which contains the first additional information.

16. The image managing device according to claim 14, wherein the fundamental information is accompanying information which is related to the first additional information.

17. The image managing device according to claim 15, wherein the additional information is a personal keyword of an object person that appears as an image in the image file.

18. The image managing device according to claim 14, wherein the fundamental information and the characteristic information is information showing characteristics of an object on image that appears as an image in the image file.

19. The image managing device according to claim 18, wherein the fundamental information and the characteristic information is a plurality of pieces of information showing characteristics of the object person as appeared as an image.

20. The image managing device method according to claim 18, wherein
the accompanying information processing unit further extracts a type of the object as the characteristic information from information which shows characteristics of the object on image, and searches the fundamental information in the database, which is similar to the information showing the characteristics of the object on image and the type, for obtaining the first additional information.

21. The image managing device according to claim 14, wherein, the accompanying information processing unit extracts, from the image file, information showing characteristics of an object person on image that appears in the image file as the characteristic information, identifies the object person from the extracted information which is the characteristic of the object person on image, and performs communication between an information apparatus which is owned by the identified object person so as to obtain the fundamental information regarding the object person from the information apparatus.
